(19) United States
(12) Patent Application Publication
(10) Pub. No.: US 2015/0309767 A1
(43) Pub. Date: Oct. 29, 2015

(54) ADAPTIVE CONTROL OF AN AUDIO UNIT USING MOTION SENSING

(71) Applicant: FREESCALE SEMICONDUCTOR, INC., AUSTIN, TX (US)

(72) Inventors: Bryce T. Osoinach, Phoenix, AZ (US); Lawrence T. Roshak, Chandler, AZ (US)

(21) Appl. No.: 14/259,971

(22) Filed: Apr. 23, 2014

(51) Int. Cl. G06F 3/16; B60Q 5/00; B60R 25/24

(52) U.S. Cl. CPC G06F 3/165; B60R 25/24; B60Q 5/001; H04R 2430/01

(57) ABSTRACT

A system for adaptive control of an audio unit associated with a vehicle includes an electronic key fob, wherein the electronic key fob includes a sensor adapted to detect a motion event imposed on the electronic key fob by a user and a controller coupled to the sensor and configured to produce a control signal in response to the motion event. The system further includes a receiver installed in the vehicle and adapted to receive the control signal and another controller installed in the vehicle and interconnected between the receiver and the audio unit. The vehicle-based controller utilizes the control signal to adjust a volume of a sound produced by the audio unit.

### TECHNICAL FIELD OF THE INVENTION

The present invention relates generally to the remote control of vehicle functions. More specifically, the present invention relates to adaptive control of an audio unit, such as a vehicle horn or speaker, using motion sensing.

### BACKGROUND OF THE INVENTION

Many vehicles come with electronic key fobs that are used for activating functions such as remote keyless entry systems. Typically, a vehicle or an electronic key fob generates some kind of audible sound in response to a button press on the key fob. Each model designer selects a sound that the vehicle will make upon activation of a remote keyless entry system from, for example, blowing a horn to emitting a quiet beep from a speaker. Each sound can be problematic. A horn sound may be too loud and can be annoying to the user when the user is close to his or her vehicle. However, a horn sound provides a value add of assistance in locating a vehicle in a parking lot or parking garage. Conversely, a quiet beep may be less annoying when the user is close to his or her vehicle, but may not make a sufficiently loud sound to provide adequate assistance in locating the vehicle in a parking lot or parking garage.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, the Figures are not necessarily drawn to scale, and:

FIG. 1 shows a pictorial representation of an electronic key fob utilized to provide adaptive volume control of an audio unit associated with a vehicle using motion sensing;

FIG. 2 shows a functional block diagram of a system for adaptive adjustment of an audio unit associated with a vehicle

FIG. 3 shows a flowchart of an adaptive volume adjustment process;

FIG. 4 shows an exemplary graphical representation of the identification of a shake event component of a motion event determined from dynamic acceleration imposed on the electronic key fob of FIG. 1;

FIG. 5 shows an exemplary graphical representation of the identification of a tilt event component of a motion event determined from static acceleration imposed on the electronic key fob; and

FIG. 6 shows an exemplary graphical representation of the control of a volume setting for adjusting the sound to be emitted from an audio unit in response to sensed motion of the electronic key fob.

### DETAILED DESCRIPTION

Embodiments of the invention entail an electronic key fob for use with a vehicle, a system that includes the electronic key fob, and methodology for adaptive control of an audio unit associated with the vehicle. More particularly, embodiments entail the inclusion of a sensor, such as an accelerometer, within the electronic key fob and control logic adapted to integrate motion data from the sensor in order to control the output of an audio unit, such as a horn or speaker. By integrating motion data from the sensor in the time just before to just after a button actuation on the electronic key fob, the user's intent may be determined. The user's intent may be, for example, locking or unlocking the vehicle via remote keyless entry, lowering windows, lowering a convertible top, opening a trunk, and so forth. Once the user's intent is intuitively ascertained from the integrated motion data, the output of the audio unit can be set in response to the integrated value.

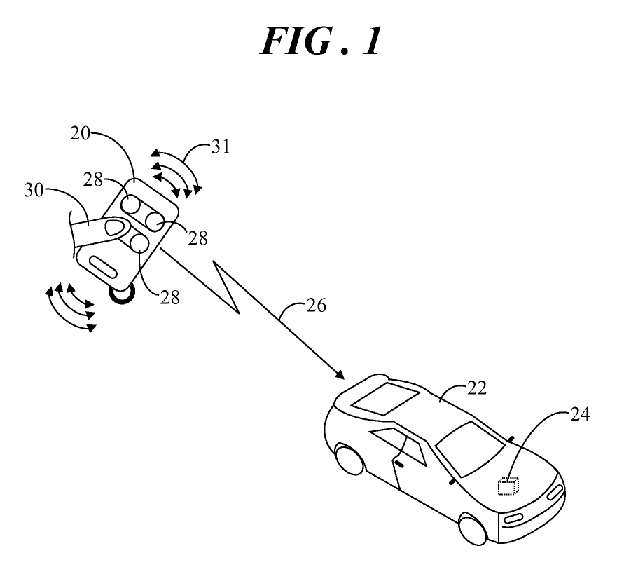

FIG. 1 shows a pictorial representation of an electronic key fob 20 utilized to provide adaptive volume control of an audio unit associated with a vehicle 22 using motion sensing. A remote keyless system (RKS) 24 is mounted within vehicle 22. The term “remote keyless system,” refers to a lock that uses an electronic remote control as a key without physical contact. When within a few yards of the car, pressing a button on the remote control device can lock or unlock the doors, and may perform other functions. RKS 24 is not visible from the exterior of vehicle 22. Therefore, RKS 24 is represented as a box in dotted line format for simplicity. Electronic key fob 20 is associated with RKS 24 and is identifiable by a unique frequency match to enable only key fob 20 to transmit wireless signals 26 for receipt at RKS 24 which are recognized by RKS 24 as being valid for vehicle control functions.

In general, key fob 20 may include one or more controllers, which may be adapted to execute control functions stored in memory. Electronic key fob 20 may include one or more actuators or buttons 28 that may be actuated by a user 30. Buttons 28 are associated with a particular vehicle function, such as locking or unlocking the vehicle doors and/or trunk or hatch, lowering the vehicle windows, remotely starting the vehicle engine, flashing the vehicle horns and/or lights, initiating a panic mode, and so forth. It should be understood that the shape and size of key fob 20, and the quantity and functions designated by buttons 28 can have any configuration.

User 30 generates motion events when he or she moves, shakes, or tilts electronic key fob 20. The motion events are represented by bidirectional curved arrows 31 to represent oscillatory and/or tilt motion of electronic key fob 20. Evaluation has revealed that there is good correlation between the motion of electronic key fob 20 and a user's intent. That is, when user 30 attempts to unlock vehicle 22 using the remote keyless entry feature of electronic key fob 20, user 30 typically imposes motion event 31 upon electronic key fob 20 that has different characteristics than motion event 31 imposed upon electronic key fob 20 when user 30 locks vehicle 22. During an unlocking activity, user 30 may reach for key fob 20, point or otherwise upwardly tilt key fob 20, and/or impart a shaking or other relatively high frequency oscillatory motion on key fob 20. Conversely, a locking action tends to result in less motion and/or a downward tilt of key fob 20 because key fob 20 is being placed in or is already located in a purse or pocket.

In an embodiment, by utilizing motion sensing, the output of the audio unit, e.g., a horn or speaker, associated with vehicle 22 can be suitably adjusted in response to greater movement of key fob 20, or alternatively, in response to less movement of key fob 20. In an example, the output of the audio unit may be the volume of sound produce the audio unit. Accordingly, the volume may be proportionally louder in response to greater movement of key fob 20, and proportionally softer in response to less movement of key fob 20. Such a technique can provide a louder and therefore more distinct sound when user 30 is attempting to locate his or her vehicle in a parking lot or garage. Likewise, such a technique can provide a quieter and therefore less annoying sound when user 30 is still near vehicle 22, for example, when user 30 locks vehicle 22 after exiting it. As such, the volume of the sound emitted from the horn or speaker can be adapted to the sensed motion. In another embodiment, the output of the audio unit may be the type of sound produced in response to greater movement of key fob 20, or alternatively, in response to less movement of key fob 20. For example, the audio unit may produce one type of sound when the door is being locked, as detected by greater movement of key fob 20, and the audio unit may produce another type of sound when the door is being unlocked, as detected by less movement of key fob 20.

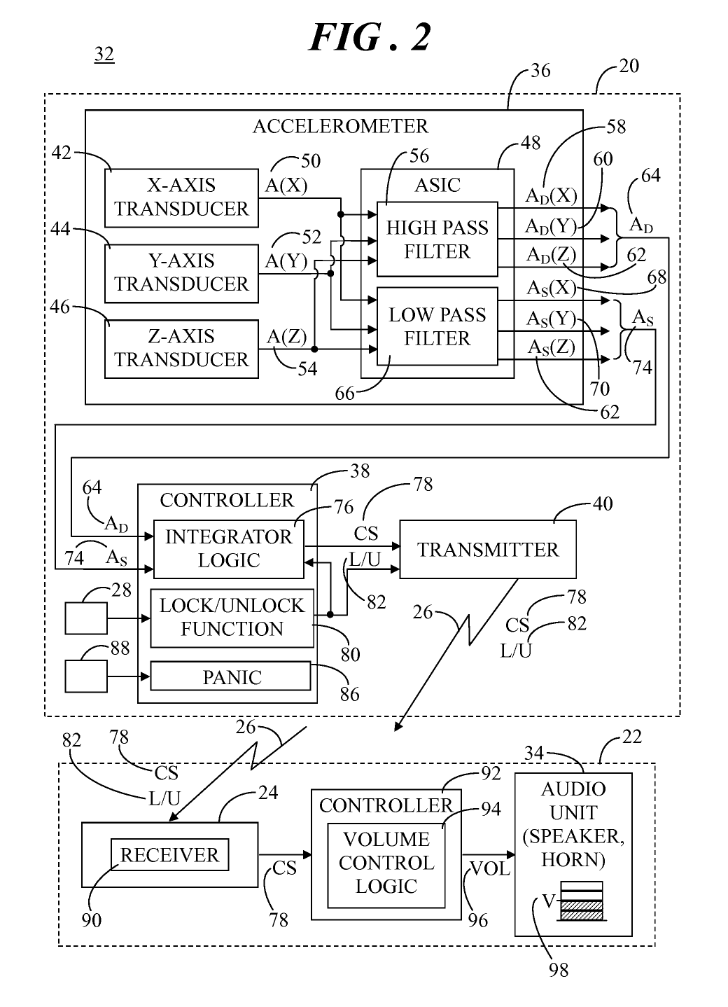

FIG. 2 shows a functional block diagram of a system 32 for adaptive volume control of an audio unit 34 associated with vehicle 22. In general, system 32 includes various elements housed in electronic key fob 20 and various elements housed in vehicle 22. Accordingly, dashed line boxes are used to represent each of key fob 20 and vehicle 22, so as to delineate the various elements housed therein.

In order to provide adaptive volume control, key fob 20 generally includes an sensor 36, a controller 38 coupled to sensor 36, and a transmitter 40 coupled to controller 38. In an embodiment, sensor 36 may be an accelerometer 36 that is adapted to sense acceleration along multiple axes. As such, sensor 36 will be referred to herein as accelerometer 36. Accelerometer 36 may include an X-axis transducer 42, a Y-axis transducer 44, and a Z-axis transducer 46, each of which is coupled to an application specific integrated circuit (ASIC) 48. ASIC 48 is shown beside transducers 42, 44, 46 for simplicity of illustration. However, ASIC 48 need not be integrated with transducers 42, 44, 46 in a side-by-side configuration. In alternative embodiments, ASIC and transducers 42, 44, 46 may be in a stacked die configuration, a monolithic configuration, or any other known or upcoming packaging configuration. Although an accelerometer is utilized herein to detect motion events, in alternative embodiments, the sensor may be an angular rate sensor, a magnetometer, or any combination of, for example, accelerometers, angular rate sensors, and/or magnetometers.

Accelerometer 36 is configured to measure the time rate of change of velocity with respect to magnitude or direction in three axes. As such, each of X-axis transducer 42, a Y-axis transducer 44, and a Z-axis transducer 46 is configured to output a corresponding X-axis acceleration signal 50, labeled A(X), Y-axis acceleration signal 52, labeled A(Y), and Z-axis acceleration signal 54, labeled A(Z). Combining X-axis acceleration signal 50, Y-axis acceleration signal 52, and Z-axis acceleration signal 54 enables detection of the motion and the orientation of key fob 20 in any direction. In an embodiment, accelerometer 36 may be a capacitive-sensing accelerometer. In general, capacitive-sensing accelerometers sense a change in electrical capacitance, with respect to acceleration, to vary the output of an energized circuit. However, alternative acceleration sensing designs may be implemented. Those skilled in the art will recognize that accelerometer can include additional elements such as, a multiplexor, capacitance-to-voltage converter, analog to digital converter, amplifier, offset and gain adjust elements, clock, control logic, and so forth not shown herein for simplicity of illustration.

In an embodiment, accelerometer 36 analyzes dynamic acceleration. Dynamic acceleration, i.e., the change in the acceleration, is analyzed to identify certain motion events 31 (see FIG. 1) such a tap, flick, shake, shock and so forth imposed on key fob 20. In order to analyze the dynamic acceleration, the static component may be removed by communicating X-axis acceleration signal 50, Y-axis acceleration signal 52, and Z-axis acceleration signal 54 to a high pass filter 56 of ASIC 48. Thus, an output of high pass filter 56 may be an X-axis dynamic acceleration signal 58, labeled A_{D}(X), a Y-axis dynamic acceleration signal 60, labeled A_{D}(Y), and a Z-axis dynamic acceleration signal 62, labeled A_{D}(Z), which are collectively referred to herein as dynamic acceleration 64.

In addition to dynamic acceleration, accelerometer 36 analyzes static acceleration. Static acceleration, i.e., the change in acceleration due to gravity only, is analyzed to identify a motion event (see FIG. 1) such as tilt imposed on key fob 20. In order to analyze the static acceleration, the dynamic component may be removed by communicating X-axis acceleration signal 50, Y-axis acceleration signal 52, and Z-axis acceleration signal 54 to a low pass filter 66 of ASIC 48. Thus, an output of low pass filter 58 may be an X-axis static acceleration signal 68, labeled A_{S}(X), a Y-axis static acceleration signal 70, labeled A_{S}(Y), and a Z-axis static acceleration signal 72, labeled A_{S}(Z), which are collectively referred to herein as static acceleration 74.

Dynamic acceleration 64 and static acceleration 74 can be communicated to controller 38 where they are analyzed by integrator logic 76 executed by controller 38 to produce a control signal 78, labeled CS. As will be discussed below, control signal 78 is used to control a volume of a sound produced by audio unit 34.

In some embodiments, controller 38 is configured to produce control signal 78 in response to motion event 31 (see FIG. 1) imposed on electronic key fob 20 during actuation of one of buttons 28 by user 30. Additionally, or alternatively, controller 38 is configured to produce control signal 78 in response to a motion event 31 imposed on the electronic key fob 20 immediately preceding actuation of one of buttons 28 by user 30. Accordingly, controller 38 may additionally include lock/unlock function logic 80 configured to produce a door lock/unlock signal 82, labeled L/U, when one of buttons 28 is actuated by user 30 (FIG. 1) in order to initiate a door lock or a door unlock function for vehicle 22.

Door lock/unlock signal 82 may be utilized by integrator logic 76 of controller 38 to determine when control signal 78 should be produced and transmitted. Control signal 78 (used to adjust the volume of audio unit 34) and door lock/unlock signal 82 (used to lock or unlock vehicle 22) are communicated to transmitter 40. Transmitter 40 produces an appropriate radiofrequency output, e.g., wireless signals 26, in which control signal 78 and door lock/unlock signal 80 are embedded or otherwise contained. Transmitter 40 may utilize a variety of frequencies, for example, the 315 Megahertz frequency band allocated to remote keyless entry systems in the United States and Japan or the 433.92 Megahertz band in Europe.

Although the exemplary illustration shows controller 38 processing signaling from buttons 28 and communicating door lock/unlock signal 82 to transmitter 40, it should be understood that this function may be performed by another controller carried in electronic key fob 20. Additionally or alternatively, it should be understood that electronic key fob 20 may contain various peripheral functions such as, for example, start vehicle functionality, trunk or hatch release, close windows, open/close power sliding doors, and a panic function 86 associated with a panic button 88 of electronic key fob 20.

Per convention, some remote keyless systems include panic button 88 which when actuated initiates panic function 86 to activate the vehicle alarm at vehicle 22. In some embodiments, motion sensing detected via accelerometer 36 may be used to initiate panic function 86. For example, electronic key fob 20 may be subjected to a certain motion event 31 (see FIG. 1) that is indicative of a panic situation. Under such a situation, it may be desirable to automatically initiate panic function 86 without physically actuating panic button 88. Thus, controller 76 may produce control signal 78 in response to the initiation of panic function 86 in order to loudly sound the vehicle alarm.

Wireless signals 26 carrying at least control signal 78 and lock/unlock signal 82 is transmitted via transmitter 40 for receipt at a receiver 90 of RKS 24 within vehicle 20. In response to receipt of lock/unlock signal 82, RKS 24 initiates a lock/unlock function in accordance with known methodologies to lock or unlock vehicle 20. Additionally, and in accordance with an embodiment, the received control signal 78 is communicated to a vehicle-based controller 92 interconnected between receiver 90 and audio unit 34.

Vehicle-based controller 92 can include volume control logic 94. Volume control logic 94 analyzes the received control signal 78 to set the volume, i.e., the amount of sound that is produced by audio unit 34. That is, volume control logic 94 may output a volume signal 96, labeled VOL, that is communicated to audio unit 34. Volume signal 96 is produced in response to control signal 78, and control signal 78 is produced in response to the motion detected via accelerometer 36. Therefore, the amount of sound emitted by audio unit 34 can be intuitively or adaptively controlled based upon motion imposed on electronic key fob 20 by user 30. The volume of the sound to be emitted from audio unit 34 is represented by a vertically arranged volume indicator bar in FIG. 2, and is referred to hereinafter as volume 98. In other embodiments, vehicle-based controller 92 may include sound control logic that analyzes the received control signal 78 in order to select a particular sound that will be output from audio unit 34 in response to the motion detected via accelerometer 36.

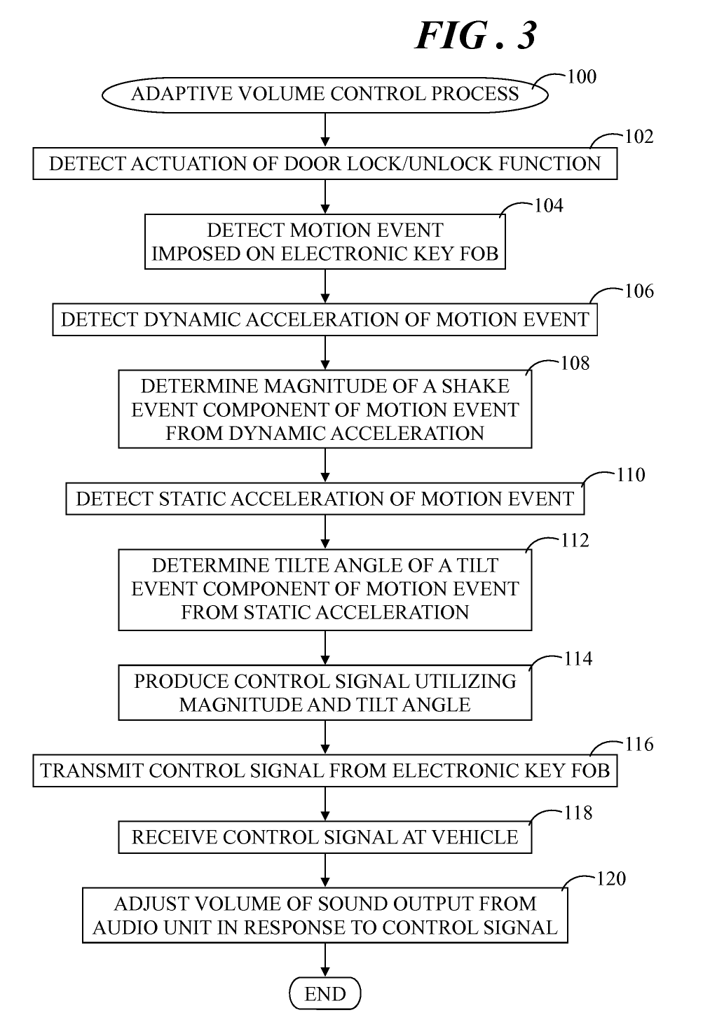

FIG. 3 shows a flowchart of an adaptive volume control process 100 performed to adjust volume 98 in response to the sensed motion of electronic key fob 20. Process 100 is executed utilizing system 32 (FIG. 2) which includes components and logic contained in electronic key fob 20 and vehicle 22. Accordingly, reference should additionally be directed to system 32 shown in FIG. 2 during the ensuing discussion of adaptive volume control process 100.

Adaptive volume control process 100 may be initiated upon detection (102) of actuation of door lock/unlock function 80. Upon detection (102), motion event 31 (see FIG. 1) imposed on electronic key fob 20 by user 30 (see FIG. 1) is detected (104) by accelerometer 36. That is, X-axis, Y-axis, and Z-axis acceleration signals 50, 52, 54 are output by transducers 42, 44, 46.

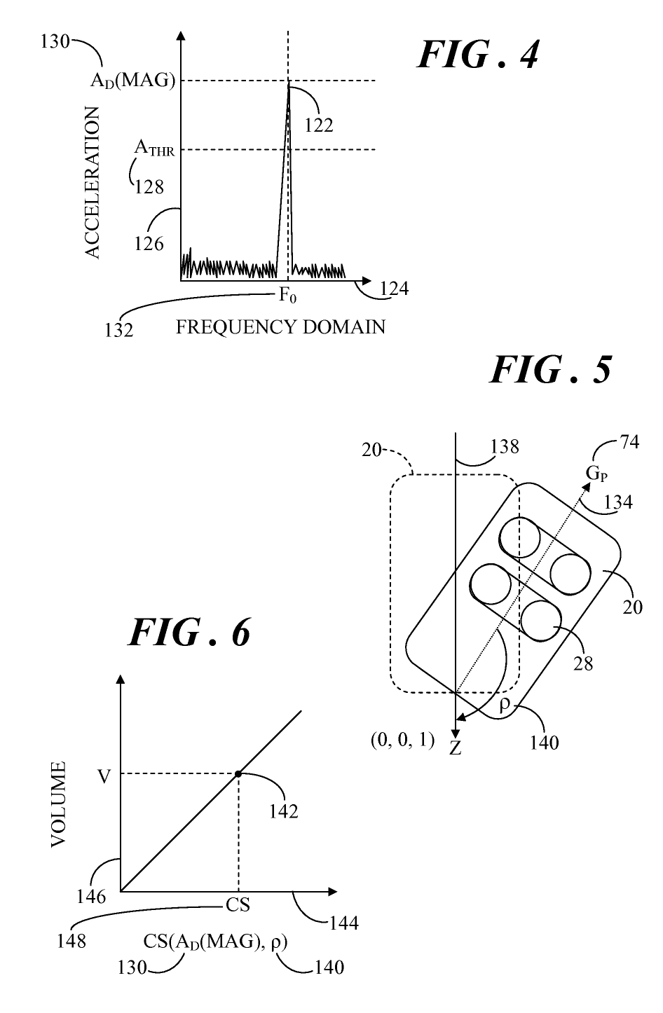

Dynamic acceleration 64 is detected (106) following high pass filtering of the raw acceleration signals 50, 52, 54 to obtain X-axis, Y-axis, and Z-axis dynamic acceleration signals 58, 60, 62. Accelerometer 36 determines (108) a magnitude (discussed below in connection with FIG. 4) of a shake event component of motion event 31 from dynamic acceleration 64. Likewise, static acceleration 74 is detected (110) following low pass filtering of the raw acceleration signals 50, 52, 54 to obtain X-axis, Y-axis, and Z-axis static acceleration signals 68, 70, 72. Accelerometer 36 determines (112) a tilt angle (discussed below in connection with FIG. 5) of a tilt event component of motion event 31 from static acceleration 74. Controller 38, executing integrator logic 76, produces (114) control signal 78 utilizing the determined magnitude and tilt angle.

Control signal 78 is transmitted (116) from transmitter 40 of electronic key fob 20 and is received (118) at vehicle 22. Additionally, lock/unlock signal 82 can be transmitted from transmitter 40 of electronic key fob for receipt at vehicle 22. Controller 92, executing volume control logic 94, receives control signal 78 and utilizes (120) control signal 78 to adjust volume 98 of sound output from audio unit 34. That is, volume control logic 94 generates volume signal 96 which is then communicated to audio unit 34. In response, audio unit 34 will emit sound, for example, a horn sound, a beep sound, or any other sound at volume 98 adjusted in response to the detected motion event 31. Thereafter, an iteration of adaptive volume control process 100 ends.

Referring jointly to FIGS. 2 and 4, FIG. 4 shows an exemplary graphical representation of the identification of a shake event component 122 of motion event 31 determined from dynamic acceleration 64 imposed on electronic key fob 20. Shake event component 122 may be determined at task 108 of adaptive volume control process 100 (see FIG. 3). The graphical representation shows a frequency domain scale 124 on a horizontal axis and acceleration magnitude scale 126 on a vertical axis. In this highly simplified view, shake event component 122 may be identified when it exceeds an acceleration magnitude threshold 128. A magnitude 130 may be determined as, for example, a peak acceleration at a fundamental frequency 132 of dynamic acceleration 64.

In an example, the transducer output of accelerometer 36, e.g., X-axis acceleration signal 50, Y-axis acceleration signal 52, and Z-axis acceleration signal 54, may be signal conditioned and bandwidth limited via high pass filter 56 based on the accelerometer characteristics to obtain X-axis dynamic acceleration signal 58, Y-axis dynamic acceleration signal 60, and Z-axis dynamic acceleration signal 62. Signals 58, 60, 62 may be collected and data logged in time. The frequency of the time domain signal can be calculated and analyzed or otherwise processed to obtain magnitude 130 of the fundamental frequency. Of course, those skilled in the art will recognize that a variety of techniques can be implemented within accelerometer 36 and/or within integrator logic 76 executed by controller 38 to identify shake event component 122 in the time domain and/or in the frequency domain, and to determine magnitude 130 thereof.

Referring jointly to FIGS. 2 and 5, FIG. 5 shows an exemplary graphical representation of the identification of a tilt event component 134 of motion event 31 (FIG. 1) determined from static acceleration 74 imposed on electronic key fob 20. Tilt event component 134 may be determined at task 112 of adaptive volume control process 100 (see FIG. 3). The graphical representation shows a vertical Z-axis 138, where Z-axis 138 represents the gravitational field component. In this highly simplified view, tilt event component 134 may be identified when electronic key fob 20 tilts away from the direction of the gravitational field component, i.e., Z-axis 138. A tilt angle 140, p, associated with tilt event component 134 may be determined from static acceleration 74. Tilt angle 140 defines an orientation of electronic key fob 20 away from the gravitational field component, i.e., Z-axis 138.

Tilt angle 140 is typically determined in the absence of linear acceleration. In this example, the transducer output of accelerometer 36, e.g., X-axis acceleration signal 50, Y-axis acceleration signal 52, and Z-axis acceleration signal 54, may be signal conditioned and bandwidth limited via low pass filter 66 based on the accelerometer characteristics to obtain X-axis static acceleration signal 68, Y-axis static acceleration signal 70, and Z-axis static acceleration signal 72. As known to those skilled in the art, static acceleration 74, A_{S}, in the absence of linear acceleration may be represented as follows:

$${G}_{P} ( \begin{matrix}0 \\ 0 \\ 1\end{matrix} ) = {G}_{pz} = \vert {G}_{p} \vert cos ρ ⇒ cos ρ = \frac{{G}_{pz}}{\sqrt{{G}_{px}^{2} + {G}_{py}^{2} + {G}_{pz}^{2}}} \qquad ( 1 )$$

Where Gₚ represents static acceleration 74, and is a vector matrix of roll rotation, pitch rotation, and yaw rotation. And, Gₚₓ is representative of X-axis static acceleration signal 68, G_{py} is representative of Y-axis static acceleration signal 70, and G_{pz} is representative of Z-axis static acceleration signal 72. Thus, tilt angle 140, p, in the absence of linear acceleration, may be determined from equation (1). Of course, those skilled in the art will recognize that a variety of techniques can be implemented within accelerometer 36 and/or within integrator logic 76 executed by controller 38 to identify tilt event component 134 and to determine tilt angle 140.

Referring jointly to FIGS. 2 and 6, FIG. 6 shows an exemplary graphical representation of the control of a volume setting 142 for adjusting volume 98 of the sound to be emitted from audio unit 34 in response to the sensed motion of electronic key fob 20. Volume setting 142 may be generated by volume control logic 94 of controller 92 and may be used to generate volume signal 96 and thereby adjust volume 98 of audio unit 34 associated with vehicle 22. The graphical representation shows a control signal scale 144 for values of control signal 78 on a horizontal axis and a volume scale 146 of volume settings on a vertical axis.

In this highly simplified example, a value 148 for control signal 78 is produced utilizing magnitude 130 of dynamic acceleration 64 and tilt angle 140. Volume setting 142 may be directly proportional to a combination of magnitude 130 and tilt angle 140. In a scenario, volume setting 142, and hence volume 98, increases as magnitude 130 of dynamic acceleration 64 increases. Likewise, volume setting 142, and hence volume 98, increases as tilt angle 140 increases. Thus, volume 98 of sound to be emitted from audio unit 34 will be relatively loud. Such a scenario can represent a condition in which user 30 (FIG. 1) lifts electronic key fob 20 and applies pressure to one of buttons 28 (FIG. 1) to impose motion event 31 (FIG. 1). This motion event 31 can include a relatively high magnitude shake event component 122 (FIG. 4) and an upwardly directed tilt event component 134 (FIG. 5). This condition may occur when vehicle 22 is being unlocked. Therefore, the relatively high volume 98 of sound emitted from audio unit 34 can by used as a vehicle locator for user 30.

In another scenario, volume setting 142, and hence volume 98, decreases as magnitude 130 of dynamic acceleration 64 decreases. Likewise, volume setting 142, and hence volume 98, decreases as tilt angle 140 decreases. Thus, volume 98 of sound to be emitted from audio unit 34 will be relatively quiet. Such a scenario represents a motion event 31 that may be indicative of user 30 placing electronic key fob 20 in his or her pocket or purse when vehicle 22 is being locked. The relatively quiet volume 98 of sound emitted from audio unit 34 can be less annoying to user 30 who may still be in close proximity to vehicle 20.

It should be understood that the presented scenarios are illustrative in nature, and that a large variety of scenarios could be conceived in which volume setting 142 is determined using magnitude 130 and/or tilt angle 140 to provide adaptive volume control of audio unit 34 using the sensed motion of electronic key fob 20. Furthermore, alternative embodiments may entail generating volume setting 142 as a function of weighted values of magnitude 130 and/or tilt angle 140.

By now, it should be appreciated that embodiments of the invention entail an electronic key fob for use with a vehicle; a system that includes the electronic key fob; and methodology for adaptive volume control of an audio unit associated with the vehicle. More particularly embodiments entail the inclusion of a sensor, such as accelerometer, within the electronic key fob and control logic adapted to integrate motion data from the sensor in order to control the output, such as volume, of an audio unit, such as a horn or speaker. By integrating motion data from the sensor in the time just before to just after a button actuation on the electronic key fob, the user's intent may be determined. The user's intent may be, for example, locking or unlocking the vehicle via remote keyless entry. Once the user's intent is intuitively ascertained from the integrated motion data, the output of the audio unit can be set as proportional to the integrated value. The adaptive adjustment of, for example, volume can provide a louder and therefore more distinct sound when, for example, a user is attempting to locate his or her vehicle. Likewise, the adaptive adjustment of volume can provide a quieter and therefore less annoying sound when the user 30 may still be in close proximity to the vehicle.

One embodiment of the invention provides an electronic key fob for use with a vehicle. The electronic key fob includes a sensor adapted to detect a motion event imposed on the electronic key fob by a user and a controller coupled to the sensor and configured to produce a control signal in response to the motion event. The control signal is used to control an output of an audio unit associated with the vehicle.

Another embodiment of the invention provides a system for adaptive control of an audio unit resident in a vehicle. The system comprises an electronic key fob for use with the vehicle. The electronic key fob includes a sensor adapted to detect a motion event imposed on the electronic key fob by a user, a first controller coupled to the sensor and configured to produce a control signal in response to the motion event, and a transmitter coupled to the controller for outputting the control signal. The system further includes a receiver installed in the vehicle and adapted to receive the control signal and a second controller installed in the vehicle and interconnected between the receiver and the audio unit, wherein the control signal is communicated from the receiver to the second controller and the second controller uses the control signal to adjust an output of the audio unit.

Yet another embodiment of the invention provides a method for adaptive control of an audio unit associated with a vehicle. The method includes detecting a motion event imposed on an electronic key fob associated with the vehicle by a user, producing a control signal in response to the motion event, and adjusting an output of the audio unit in response to the control signal.

While the principles of the inventive subject matter have been described above in connection with specific embodiments, it is to be clearly understood that the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims. The various functions or processing blocks discussed herein and illustrated in the Figures may be implemented in hardware, firmware, software or any combination thereof. Further, the phraseology or terminology employed herein is for the purpose of description and not of limitation.

The foregoing description of specific embodiments reveals the general nature of the inventive subject matter sufficiently so that others can, by applying current knowledge, readily modify and/or adapt it for various applications without departing from the general concept. Therefore, such adaptations and modifications are within the meaning and range of equivalents of the disclosed embodiments. The inventive subject matter embraces all such alternatives, modifications, equivalents, and variations as fall within the spirit and broad scope of the appended claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. cm What is claimed is:

1. An electronic key fob for use with a vehicle comprising:
a sensor configured to detect a motion event imposed on said electronic key fob by a user; and
a controller coupled to said sensor and configured to produce a control signal in response to said motion event, said control signal being used to control an output of an audio unit associated with said vehicle.

2. The electronic key fob of claim 1 further comprising an actuator for initiating one of a door lock and door unlock function for said vehicle, and said controller is configured to produce said control signal in response to said motion event imposed on said electronic key fob during actuation of said actuator by said user.

3. The electronic key fob of claim 1 further comprising an actuator for initiating one of a door lock and door unlock function for said vehicle, and said controller is configured to produce said control signal in response to said motion event imposed on said electronic key fob immediately preceding actuation of said actuator by said user.

4. The electronic key fob of claim 1 wherein:
said sensor comprises an accelerometer, said accelerometer including a high pass filter adapted to detect dynamic acceleration, said dynamic acceleration identifying said motion event as a shake event, and said accelerometer is configured to determine a magnitude of said shake event from said dynamic acceleration; and
said controller is configured to produce said control signal in response to said magnitude.

5. The electronic key fob of claim 4 wherein said control signal is used to increase a volume of a sound produced by said audio unit in proportion to an increase in said magnitude of said shake event relative to an acceleration threshold.

6. The electronic key fob of claim 1 wherein:
said sensor comprises an accelerometer, said accelerometer including a low pass filter adapted to detect static acceleration, said static acceleration identifying said motion event as a tilt event, and said accelerometer is configured to determine a tilt angle associated with said tilt event from said static acceleration, said tilt angle defining an orientation of said electronic key fob away from a direction of a gravitational field component; and
said controller is configured to produce said control signal in response to said tilt angle.

7. The electronic key fob of claim 6 wherein said control signal produced by said controller is used to decrease a volume of a sound produced by said audio unit in proportion to a decrease of said tilt angle relative to said gravitational field component and increase said volume in proportion to an increase of said tilt angle relative to said gravitational field component.

8. The electronic key fob of claim 1 wherein:
said sensor comprises an accelerometer, said accelerometer including:
a high pass filter adapted to detect dynamic acceleration, said dynamic acceleration identifying said motion event as including a shake event component, and said accelerometer is configured to determine a magnitude of said shake event component from said dynamic acceleration; and
a low pass filter adapted to detect static acceleration, said static acceleration identifying said motion event as including a tilt event component, and said accelerometer is configured to determine a tilt angle associated with said tilt event component from said static acceleration, said tilt angle defining an orientation of said electronic key fob relative to a gravitational field component; and
said controller is configured to produce said control signal in response to both of said both of said magnitude of said shock event component and said tilt angle associated with said tilt event component.

9. The electronic key fob of claim 1 wherein said vehicle comprises a receiver, said audio unit is resident in said vehicle, and said electronic key fob further comprises a transmitter coupled to said controller for outputting said control signal for receipt at said receiver.

10. A system for adaptive control of an audio unit associated with a vehicle comprising:
electronic key fob for use with said vehicle, said electronic key fob including a sensor adapted to detect a motion event imposed on said electronic key fob by a user, a first controller coupled to said sensor and configured to produce a control signal in response to said motion event, and a transmitter coupled to said first controller for outputting said control signal;
a receiver installed in said vehicle and adapted to receive said control signal; and
a second controller installed in said vehicle and interconnected between said receiver and said audio unit, wherein said control signal is communicated from said receiver to said second controller and said second controller uses said control signal to adjust an output of said audio unit.

11. The system of claim 10 wherein said electronic key fob further comprises an actuator for initiating one of a door lock and door unlock function for said vehicle, and said first controller is configured to produce said control signal in response to said motion event imposed on said electronic key fob during actuation of said actuator by said user.

12. The system of claim 10 wherein:
said sensor comprises an accelerometer, said accelerometer including a high pass filter adapted to detect dynamic acceleration, said dynamic acceleration identifying said motion event as a shake event, and said accelerometer is configured to determine a magnitude of said shake event from said dynamic acceleration; and
said first controller is configured to produce said control signal in response to said magnitude.

13. The system of claim 10 wherein:
said sensor comprises an accelerometer, said accelerometer including a low pass filter adapted to detect static acceleration, said static acceleration identifying said motion event as a tilt event, and said accelerometer is configured to determine a tilt angle associated with said tilt event from said static acceleration, said tilt angle defining an orientation of said electronic key fob away from a direction of a gravitational field component; and
said first controller is configured to produce said control signal in response to said tilt angle.

14. The system of claim 10 wherein said audio unit comprises a vehicle horn.

15. The system of claim 10 wherein said audio unit comprises a speaker.

16. A method for adaptive control of an audio unit associated with a vehicle comprising:
detecting a motion event imposed on an electronic key fob associated with said vehicle by a user;
producing a control signal in response to said motion event; and
adjusting an output of said audio unit in response to said control signal.

17. The method of claim 16 further comprising actuating one of a door lock and a door unlock function for said vehicle, wherein said control signal is produced in response to said motion event imposed on said electronic key fob during said actuating.

18. The method of claim 16 wherein:
said detecting detects dynamic acceleration, said dynamic acceleration identifying said motion event as a shake event;
determining a magnitude of said shake event from said dynamic acceleration, wherein said control signal is produced in response to said magnitude; and
said adjusting includes utilizing said control signal to increase a volume of a sound produced by said audio unit in proportion to an increase in said magnitude of said shake event relative to an acceleration threshold.

19. The method of claim 16 wherein:
said detecting detects static acceleration, said static acceleration identifying said motion event as a tilt event;
determining a tilt angle associated with said tilt event from said static acceleration, said tilt angle defining an orientation of said electronic key fob away from a direction of a gravitational field component, wherein said control signal is produced in response to said tilt angle; and
said adjusting includes utilizing said control signal to decrease a volume of a sound produced by said audio unit in proportion to a decrease of said tilt angle relative to said gravitational field component and increase said volume in proportion to an increase of said tilt angle relative to said gravitational field component.

20. The method of claim 16 wherein said audio unit comprises at least one of a vehicle horn and a speaker.
